(19) United States
(12) Patent Application Publication
(10) Pub. No.: US 2013/0081746 A1
(43) Pub. Date: Apr. 4, 2013

(54) PNEUMATIC TIRE

(71) Applicant: Makoto Yoshikawa, Osaka-shi (JP)

(72) Inventor: Makoto Yoshikawa, Osaka-shi (JP)

(73) Assignee: TOYO TIRE & RUBBER CO., LTD., Osaka (JP)

(21) Appl. No.: 13/629,831

(22) Filed: Sep. 28, 2012

(30) Foreign Application Priority Data
Sep. 29, 2011 (JP) 2011-215118

(51) Int. Cl. B60C 13/04

(52) U.S. Cl. 152/524

(57) ABSTRACT

A pneumatic tire including a white rubber part arranged outward in a tire radial direction than an outer edge of a bead filler in a side wall part, a white letter part projecting from the white rubber part, and a side reinforcement layer extending in a tire radial direction from a bead part is disclosed. An outer peripheral edge of the side reinforcement layer is located outward in a tire radial direction than an inner peripheral edge of a white letter part. When a length in a tire radial direction of from an inner peripheral edge of a bead core to the inner peripheral edge of the white letter part is H1, a length in a tire radial direction of from the inner peripheral edge of the bead core to the outer peripheral edge of the side reinforcement layer is H2, and a length in a tire radial direction of the white letter part is T, (H2−H1)/T is set to be 0.3 or more.

### BACKGROUND OF THE INVENTION

1. Technical Field

The present invention relates to a pneumatic tire having a white rubber provided on a side wall part.

2. Background Art

A pneumatic radial tire having various white patterns formed by a white rubber provided on a side wall part to increase fashionability is conventionally known in tires mainly used in high-load vehicles such as RV (recreation vehicles). The white rubber is generally arranged on a region near a bead part, than a tire greatest width position causing large deflection during running.

The white rubber cannot use carbon black having high reinforcing property in order to maintain its white color, is soft as compared with the ordinary rubber constituting a bead part, a side wall part and the like, and has low rigidity. For this reason, strain caused in the vicinity of the bead part by repetition of compression and tension during running easily concentrates in an interface between the white rubber and a rubber jointed thereto, and separation of a wind-up ply may occur, leading to tire failure.

JP-A2010-115964 discloses a pneumatic tire having a white rubber provided at the outside of a bead filler embedded in a bead part, wherein a portion near the white rubber, of the bead filler is constituted of a rubber softer than other portions. However, in the constitution described in this patent document, the bead filler must be enlarged outward in a tire radial direction in order to provide the white rubber at the outside of the bead filler. As a result, the amount of a bead filler rubber is increased, and additionally the thickness at the bead core side of the bead filler is increased in a tire width direction, thereby the amount of heat generation in the vicinity of the bead part is increased. This gives rise to the problem that durability is decreased under high speed running conditions.

JP-A2004-249870 discloses a pneumatic tire having a white rubber provided on a side wall part, wherein a reinforcement layer extending outward in a tire radial direction from a bead filler is provided. In the constitution of this patent document, the reinforcement layer extending outward in a tire radial direction from a bead filler is terminated inward in a tire radial direction by the white rubber. This constitution gives rise to the problem that strain generated in the vicinity of a bead part by repetition of compression and tension during running concentrates in the interface between the white rubber and a rubber jointed thereto, and durability is decreased.

### SUMMARY OF THE INVENTION

The present invention has been made in view of the above circumstances, and has an object to provide a pneumatic tire capable of exerting excellent durability although a white rubber is provided on a side wall part.

The pneumatic tire according to an embodiment of the present invention comprises:

a pair of right and left bead parts comprising embedded therein a bead core and a bead filler provided at the outside in a tire radial direction of the bead core;

a pair of right and left side wall parts provided at the outside in a tire radial direction from the right and left bead parts;

a tread part provided between the right and left side wall parts;

a white letter part projecting from a white rubber provided outward in a tire radial direction than an outer peripheral edge of the bead filler in the side wall part; and

a side reinforcement layer extending outward in a tire radial direction from the bead part,

wherein an outer peripheral edge of the side reinforcement layer is located outward in a tire radial direction than an inner peripheral edge of the white letter part, and

when a length in a tire radial direction of from the inner peripheral edge of the bead part to the inner peripheral edge of the white letter part is H1, a length in a tire radial direction of from the inner peripheral edge of the bead part to the outer peripheral edge of the side reinforcement layer is H2, and a length in a tire radial direction of the white letter part is T, (H2−H1)/T is 0.3 or more.

### BRIEF DESCRIPTION OF THE DRAWINGS

FIG. 1 is a half cross-sectional view of the pneumatic tire according to one embodiment.

FIG. 2 is an enlarged cross-sectional view of the essential parts of the pneumatic tire of FIG. 1.

FIG. 3 is a view schematically showing the constitution of the side reinforcement layer inside the pneumatic tire of FIG. 1.

### DETAILED DESCRIPTION OF THE INVENTION

The pneumatic tire according to the embodiment of the present invention is a radial tire comprising a pair of right and left bead parts 1, a pair of right and left side wall parts 2 extending outward in a tire radial direction from each of the right and left bead parts 1, a tread part 3 continuing to each outer peripheral edge of the right and left side wall parts 2, and a carcass ply 4 provided so as to bridge between a pair of the bead parts 1.

A ring-shaped bead core 1a comprising a rubber-covered bundle of, for example, steel wires, and a bead filler 1b having a triangular cross-section and located at the outside in a tire radial direction of the bead core 1a are embedded in the bead part 1.

The carcass ply 4 is wound up so as to sandwich the bead core 1a and the bead filler 1b, and its edge is locked. An inner liner 5 for maintaining air pressure is arranged at the inside of the carcass ply 4.

A belt layer 6 and a belt reinforcement layer 7 are arranged at the outside of the carcass ply 4 of the tread part 3, and a tread rubber 8 is further arranged at the outside of the belt reinforcement layer. A rim protector 9 that comes into contact with a rim flange when a tire has been mounted to vehicles is arranged at the outside of a wind-up part 4a wound up on the bead filler 1b in the carcass ply 4.

Black-colored highly reinforcing rubber having carbon black therein is used in a side wall rubber 10 provided at the outside of the carcass ply 4 of the side wall part 2, and the tread rubber 8. In the pneumatic tire of the present embodiment, a white rubber part 11 comprising a white rubber having white color is circularly arranged along a circumferential direction in a region near the bead part 1 of the side wall part 2.

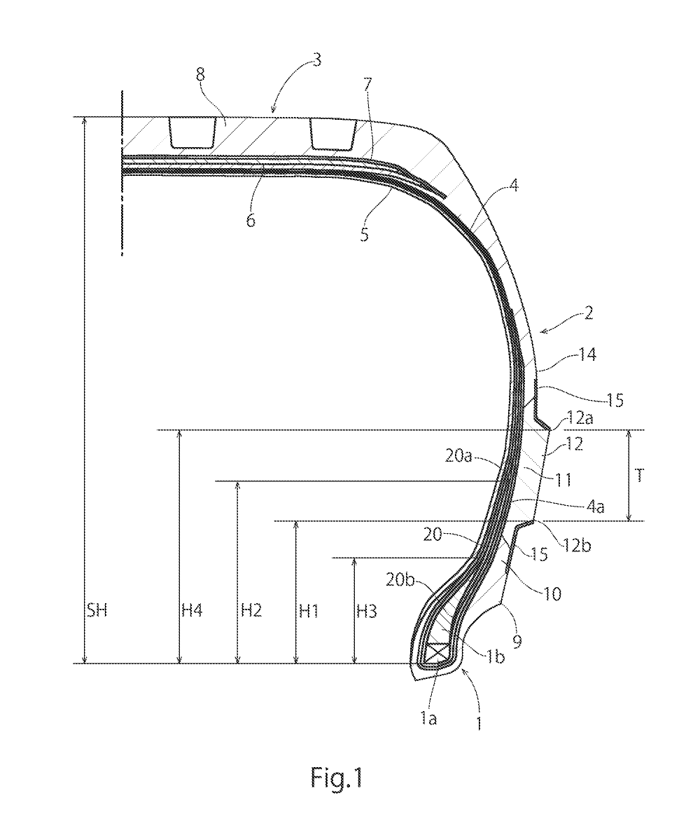

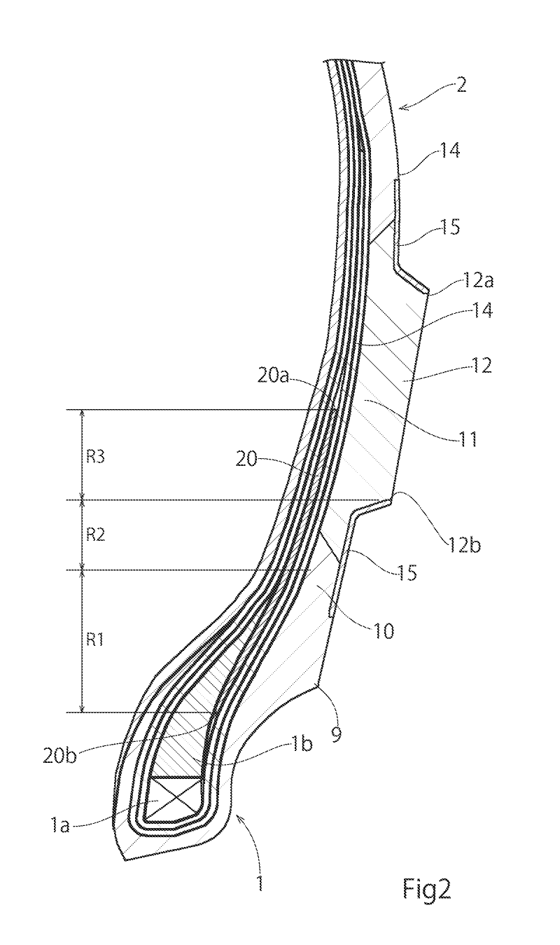

As shown in FIGS. 1 and 2, the white rubber part 11 inclines such that its edge narrows toward the inside in a tire width direction. The white rubber part 11 is arranged inward in a tire radial direction than a tire greatest width position 14 and outward in a tire radial direction than the top (outer peripheral edge) of the bead filler 1b. The white rubber part 11 is not always required to be arranged on the side wall parts 2 of both sides, and may be arranged on only one side becoming the outside of vehicles when a tire has been mounted to vehicles.

Rubber composition of the white rubber constituting the white rubber part 11 is known, and the present invention can use the conventionally known rubber compositions without particular limitation. Carbon black as a reinforcing material is not used in the white rubber constituting the white rubber part 11. For example, metal oxides such as alumina, magnesia and silica are used in place of carbon black. The rubber composition is constituted of a rubber softer than the rim protector 9 and the side wall rubber 10.

The white letter part 12 is constituted of the same rubber composition as the white rubber part 11, and is projected outward in a tire width direction from the white rubber part 11.

The white letter part 12 has the purpose to indicate display information such as given designs, characters, symbols and patterns on an outer surface of a tire, and is circularly provided in a continuous manner in a circumferential direction, or provided in a discontinuous manner along a circumferential direction according to a shape of display information.

Even in the case that the white letter part 12 is provided in a discontinuous manner along a circumferential direction according to a shape of display information, a tire radial direction outer edge (outer peripheral edge) 12a and a tire radial direction inner edge (inner peripheral edge) 12b of each white letter part 12 provided in a discontinuous manner are provided so as to locate on a concentric circle. In the case that a marginal part of the white letter part 12 inclines to its projection direction as in the present embodiment, the outer peripheral edge 12a and inner peripheral edge 12b of the white letter part 12 are determined by a tire width direction outside surface (that is, edge surface of the white letter part 12) as shown in FIGS. 1 and 2.

The surface of from the marginal part of the white letter part 12 to the white rubber part 11 is covered with a cover rubber layer 15 showing the same black color as the side wall rubber 10, and by this constitution, white display information projects on a tire outer surface.

In the above constitution, a side reinforcement layer 20 extending in a tire radial direction is provided in a region of from the bead part 1 to the side wall part 2 in the pneumatic tire of the present embodiment. The side reinforcement layer 20 is a rubber layer comprising reinforcement cords 22 that comprise a plurality of steel cords or organic fiber cords, arranged in parallel at given intervals, and are covered with rubber.

Radial direction inner edge (inner peripheral edge) 20b of the side reinforcement layer 20 extends outward along a tire radial direction from nearly central part in a radial direction of the bead filler 1b, and radial direction outer edge (outer peripheral edge) 20a of the side reinforcement layer 20 is located outward in a tire radial direction than the inner peripheral edge 12b of the white letter part 12. The side reinforcement layer 20 is provided so as to straddle the white rubber part 11 provided on the side wall part 2 from the bead filler 1b in a tire radial direction.

In more detail, in a meridian cross-section of the tire shown in FIG. 1, when a length along a tire radial direction of from the inner peripheral edge of the bead core 1a to the inner peripheral edge 12b of the white letter part 12 is H1, a length along a tire radial direction of from the inner peripheral edge of the bead core 1a to the outer peripheral edge 20a of the side reinforcement layer 20 is H2, and a length along a tire radial direction of the white letter part 12 is T, various dimensions of the bead part 1, the side reinforcement layer 20 and the white letter part 12 are set such that (H2−H1)/T is 0.3 or more. That is, the side reinforcement layer 20 is such that its outer peripheral edge 20a is located outward in a tire radial direction than the inner peripheral edge 12b of the white letter part 12, and extends outward in a tire radial direction from the inner peripheral edge 12b of the white letter part 12 in a length of 30% or more of the length T of the white letter part 12, and the side reinforcement layer 20 is provided along a region of 30% or more of the white letter part 12 in a tire radial direction.

Thus, when the side reinforcement layer 20 extending from the bead part 1 is arranged along 30% or more of a region of the white letter part 12 in a tire radial direction, rigidity near the interface between the white rubber part 11 and the side wall rubber 10 jointed thereto can be increased while suppressing a thickness of a portion of from the bead part 1 to the side wall part 2. This can reduce deformation or strain that easily concentrates in the interface between the white rubber part 11 and the side wall rubber 10. As a result, generation of separation is suppressed, thereby durability (general durability) can be increased, and additionally, increase in generation of heat by standing wave in high speed region is suppressed, thereby durability (high speed durability) can be increased.

When the side reinforcement layer 20 is 30% or more of a length T of the white letter part 12 outward in a tire radial direction from the inner peripheral edge 12b of the white letter part 12, the side reinforcement layer 20 may extend over the entire region of the white letter part 12. However, the outer peripheral edge 20a of the side reinforcement layer 20 is preferably located inward in a tire radial direction than the tire greatest width position 14.

When a length along in a tire radial direction of from the inner peripheral edge of the bead core 1a to the outer peripheral edge of the bead filler 1b is H3, a length along in a tire radial direction of from the inner peripheral edge of the bead core 1a to the outer peripheral edge 12a of the white letter part 12 is H4, and a height of a cross section of a tire is SH, various dimensions are set such that H4/SH is from 0.4 to 0.5, H3/SH is from 0.15 to 0.25, and H1/SH is from 0.25 to 0.35.

The inside in a tire radial direction of the side reinforcement layer 20 is provided along the outside surface in a tire width direction of the bead filler 1b, and is inserted between the bead filler 1b and the wind-up part 4a of the carcass ply 4. The outside in a tire radial direction of the side reinforcement layer 20 is covered with the wind-up part 4a of the carcass ply 4 from the outside in a tire width direction, and is provided along an inside surface in a tire width direction of the white rubber part 11 across the wind-up part 4a of the carcass ply 4.

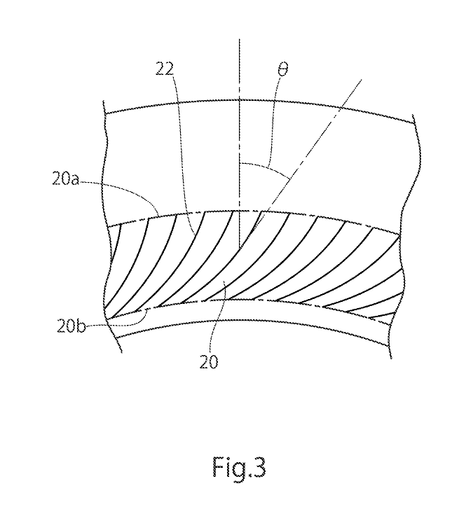

A reinforcement cord 22 provided in the side reinforcement layer 20 may be arranged with inclination to a tire radial direction as shown in FIG. 3, and in this case, inclination angle θ to a tire radial direction is preferably set to be from 10 to 60°.

End count (number of cords) of the reinforcement cord 22 can appropriately be set according to cord tensile strength and the like. For example, in the case of a steel cord, the number of ends is preferably from 14 to 23 per 25.4 mm, and in the case of an organic fiber cord, the number of ends is from 20 to 30 per 25.4 mm.

The side reinforcement layer 20 is preferably set such that rigidity of the outside in a tire radial direction is higher than that of the inside in a tire radial direction by providing the reinforcement cord 22 in a curved line shape such that the inclination angle θ to a tire radial direction is decreased toward the outside in a tire radial direction, or by setting the reinforcement cord 22 such that the number of ends thereof at the outside in a tire radial direction is increased as compared with that at the inside in a tire radial direction.

Specific example is described below. In the case of changing the inclination angle of the reinforcement cord 22, the inclination angle of the reinforcement cord arranged in a region R1 along the bead filler 1b may be set to be from 40 to 60°, the inclination angle of the reinforcement cord arranged in a region R2 of from the outer peripheral edge of the bead filler 1b to the inner peripheral edge 12b of the white letter part 12 may be set to be from 30 to 50°, and the inclination angle of the reinforcement cord arranged in a region R3 of from the inner peripheral edge 12b of the white letter part 12 to the outer peripheral edge 20a of the side reinforcement layer 20 may be set to be from 10 to 30°, as shown in FIG. 2. Furthermore, in the case of changing the number of ends of the reinforcement cord 22, for example, the number of ends of the reinforcement cord arranged in the region R1 may be set to be from 14 to 17 per 25.4 mm in the case of a steel cord, and from 20 to 24 per 25.4 mm in the case of an organic fiber cord, the number of ends of the reinforcement cord arranged in the region R2 may be set to be from 17 to 20 per 25.4 mm in the case of a steel cord, and from 24 to 27 per 25.4 mm in the case of an organic fiber cord, and the number of ends of the reinforcement cord arranged in the region R3 may be set to be from 20 to 23 per 25.4 mm in the case of a steel cord, and from 27 to 30 per 25.4 mm in the case of an organic fiber cord.

Thus, when rigidity of the side reinforcement layer 20 is set to be high in the outside in a tire radial direction than the inside in a tire radial direction, rigidity in the vicinity of the white rubber part 11 having low rigidity and rigidity in the vicinity of the interface between the white rubber part 11 and the side wall rubber 10 jointed thereto can be increased.

Furthermore, the inclination angle and the number of ends of the reinforcement cord 22 are set to be decreased in the order to the region R3, the region 2 and the region R1, and rigidity of the side reinforcement layer 20 is set to be gradually decreased. Therefore, tire rigidity over from the white rubber part 11 of the side wall part 2 to the bead part 1 can be improved with good balance.

### EXAMPLES

The present invention is further specifically described below by reference to the Examples, but the invention is not construed as being limited to those Examples.

A radial tire having a tire size of 275/70R16 and a cross-sectional shape shown in FIG. 1 was manufactured by way of trial. Constitution of the side reinforcement layer 20 is as shown in Table 1 below.

Constitutions other than the side reinforcement layer 20 were all common in the tires of Comparative Examples 1 and 2 and Examples 1 to 3. The tire of Comparative Example 3 had the same constitution as that of Example 2, except that the length H3 was changed such that the outer peripheral edge of the bead filler 1b is located outward in a radial direction than the inner peripheral edge 12b of the white letter part 12.

Each tire of Comparative Examples 1 to 3 and Examples 1 to 3 was evaluated in the following methods.

### (1) General Durability

Durability performance test was conducted according to the method defined in JIS D4230. In the case that failure such as separation was not confirmed even after completion of the test stage 3, load was continuously applied to a tire and running distance until failure had been confirmed was measured.

### (2) High Speed Durability

High speed performance test A was conducted according to the method defined in JIS D4230. In the case that failure such as separation was not confirmed even after completion of the test stage 6, speed was continuously increased 10 km/hr per every 10 minutes, and speed and time when failure occurred were measured.

TABLE 1

| | | | | | | | Comparative | | Comparative | | Comparative | |
|---|---|---|---|---|---|---|---|---|---|---|---|---|
| | Example 1 | | Example 2 | | Example 3 | | Example 1 | | Example 2 | | Example 3 | |
| SH (mm) | 192 | | 192 | | 192 | | 192 | | 192 | | 192 | |
| H4 (mm) | 85 | | 85 | | 85 | | 85 | | 85 | | 85 | |
| H2 (mm) | 64 | | 70 | | 76 | | 55 | | 58 | | 70 | |
| H1 (mm) | 55 | | 55 | | 55 | | 55 | | 55 | | 55 | |
| H3 (mm) | 35 | | 35 | | 35 | | 35 | | 35 | | 65 | |
| T (mm) | 30 | | 30 | | 30 | | 30 | | 30 | | 30 | |
| H3/SH | 0.18 | | 0.18 | | 0.18 | | 0.18 | | 0.18 | | 0.34 | |
| (H2 − H1)/T | 0.30 | | 0.50 | | 0.70 | | 0.00 | | 0.10 | | 0.50 | |
| High speed | 230 | km/h | 230 | km/h | 230 | km/h | 230 | km/h | 230 | km/h | 210 | km/h |
| durability | 7 | minutes | 10 | minutes | 10 | minutes | 5 | minutes | 3 | minutes | 2 | minutes |
| General | 11450 | km | 11500 | km | 11550 | km | 8000 | km | 8900 | km | 11200 | km |
| durability | | | | | | | | | | | | |

It is seen from Table 1 that excellent general durability and high speed durability can be exerted in Examples 1 to 3 as compared with Comparative Examples 1 to 3.

It is considered that in Comparative Examples 1 and 2, rigidity in the vicinity of the interface between the white rubber part 11 and the side wall rubber 10 jointed thereto was decreased, thereby the general durability was decreased.

It is considered that in Comparative Example 3, because the outer peripheral edge of the bead filler 1b is located outward in a radial direction than the inner peripheral edge 12b of the white letter part 12, the thickness of the bead filler 1b was increased in a tire width direction, and as a result, the amount of heat generation in the vicinity of the bead part was increased, thereby high speed durability was decreased.

What is claimed is:

1. A pneumatic tire comprising:
a pair of right and left bead parts comprising embedded therein a bead core and a bead filler provided at the outside in a tire radial direction of the bead core;
a pair of right and left side wall parts provided at the outside in a tire radial direction from the right and left bead parts;
a tread part provided between the right and left side wall parts;
a white rubber part provided outward in a tire radial direction than an outer peripheral edge of the bead filler in the side wall part;
a white letter part projecting from the white rubber part; and
a side reinforcement layer extending outward in a tire radial direction from the bead part,
wherein an outer peripheral edge of the side reinforcement layer is located outward in a tire radial direction than an inner peripheral edge of the white letter part, and
when a length in a tire radial direction of from the inner peripheral edge of the bead part to the inner peripheral edge of the white letter part is H1, a length in a tire radial direction of from the inner peripheral edge of the bead part to the outer peripheral edge of the side reinforcement layer is H2, and a length in a tire radial direction of the white letter part is T, (H2−H1)/T is 0.3 or more.

2. The pneumatic tire according to claim 1, wherein an inner peripheral edge of the side reinforcement layer is located outward in a tire radial direction than the bead core.
